(19) United States
(12) Patent Application Publication
(10) Pub. No.: US 2014/0356080 A1
(43) Pub. Date: Dec. 4, 2014

(54) HIGH SPEED PNEUMATIC SWITCH AND CARRIER STATION

(71) Applicant: TRANSLOGIC CORPORATION, Denver, CO (US)

(72) Inventor: Kenneth Michael Hoganson, Aurora, CO (US)

(73) Assignee: TRANSLOGIC CORPORATION, Denver, CO (US)

(21) Appl. No.: 14/293,680

(22) Filed: Jun. 2, 2014

Related U.S. Application Data
(60) Provisional application No. 61/830,819, filed on Jun. 4, 2013.

(51) Int. Cl. B65G 51/24

(52) U.S. Cl. CPC B65G 51/24
USPC 406/183

(57) ABSTRACT

A high speed switch for use in pneumatic tube systems. The switch includes a disk member that may be rotated about its central axis. Extending through a sidewall (e.g., cylindrical sidewall) of the disk are first and second passageways. The first passageway extends between first and second openings in the sidewall and the second passageway extends between third and fourth openings in the sidewall. These passageways and their respective openings may be selectively aligned with various pneumatic tubes to provide a transport path through the switch (i.e., via the passageway) between two pneumatic tubes.

### CROSS REFERENCE

This application claims the benefit of U.S. Provisional Application No. 61/830,819 having a filing date of Jun. 4, 2013, the entire contents of which is incorporated herein by reference.

### FIELD

The presented disclosure relates generally to pneumatic tube systems. More specifically, the disclosure is directed to a high speed transfer switch and carrier station for use in a pneumatic tube system.

### BACKGROUND

Pneumatic tube systems (PTS) are a well-known means for the automated transport of materials between, for example, an origination location and any one of a plurality of destination locations. A typical PTS includes a number of pneumatic tubes interconnected in a network to transport carriers between user stations. Various air sources/blowers and transfer units provide the force and path control means, respectively, for moving the carriers through and from tube-to-tube within the system. Simply stated, pressure differentials between two ends of the carrier, as supplied by the air source(s), are employed to propel carriers through the pneumatic tubes. Generally, transfer units move or divert pneumatic carries from a first pneumatic tube to one of a plurality of additional pneumatic tubes to route pneumatic carriers between locations, or stations, in the PTS.

In a PTS, the pneumatic tubes form a network of pathways that may be arranged in any manner. Most systems include a number of individual stations that are interconnected to the network by a single pneumatic tube. The single pneumatic tube transports carriers to and from the station under pressure and vacuum and is typically connected to a transfer device. Such transfer devices allow for redirecting pneumatic carriers to one or more additional pneumatic tubes. In this regard, carries may be routed between different stations. In any arrangement, stations are typically disposed throughout a facility for dispatching carriers to other locations within the PTS, for receiving carriers from other locations, or both.

### SUMMARY

Provided herein are systems, apparatuses and methods for increasing the resource utilization of a pneumatic tube system (PTS). The systems, apparatuses and methods (i.e., utilities) provide a high speed switch that allows for rapidly connecting different pneumatic tubes for routing carrier through a pneumatic tube system.

In a first aspect, the high speed switch comprises a disk member that may be rotated about a central axis of the disk. Extending through a sidewall (e.g., cylindrical sidewall) of the disk are first and second passageways. The first passageway extends between first and second openings in the sidewall and the second passageway extends between third and fourth openings in the sidewall. These passageways and their respective openings may be selectively aligned with various pneumatic tubes to provide a transport path through the switch (i.e., via the passageway) between two pneumatic tubes. In one arrangement, the first and second passageways intersect within an interior of the disk. In a further arrangement, one of the passageways is linear and the other passageway is arcuate. In any arrangement, an actuator may be utilized to controllably rotate the disk. In further aspects, the high speed switch may be utilized to form multiple station user stations as well as pass through user stations.

### BRIEF DESCRIPTION OF THE DRAWINGS

For a more complete understanding of the present disclosure and further advantages thereof, reference is now made to the following detailed description taken in conjunction with the drawings in which:

FIG. 1 illustrates one embodiment of a pneumatic tube system.

FIG. 2 illustrates a control system for use in controlling a pneumatic tube system.

FIG. 3 illustrates one embodiment of carrier for use in a pneumatic tube system.

FIG. 4A illustrates a perspective view of a transfer unit that transfers a single tube to one of four interconnecting tubes.

FIGS. 4B and 4C illustrates first and second sides view of the transfer unit of FIG. 4A.

FIGS. 5A-5E illustrate perspective views of a high speed transfer switch.

FIGS. 6A and 6B illustrate the high speed transfer switch in a first orientation.

FIG. 6C illustrates the high speed transfer switch in a second orientation.

FIG. 6D illustrates the high speed transfer switch in a third orientation.

FIGS. 7A and 7B illustrate a prior art user station.

FIG. 8 illustrates a pass through user station utilizing the high speed transfer unit.

FIGS. 9A-9C illustrate a multi-carrier handling turnaround transfer unit.

FIG. 10 illustrates a process for using the high speed transfer unit.

### DETAILED DESCRIPTION

Reference will now be made to the accompanying drawings, which at least assist in illustrating the various pertinent features of the presented inventions. In this regard, the following description is presented for purposes of illustration and description. Furthermore, the description is not intended to limit the disclosed embodiments of the inventions to the forms disclosed herein. Consequently, variations and modifications commensurate with the following teachings, and skill and knowledge of the relevant art, are within the scope of the presented inventions.

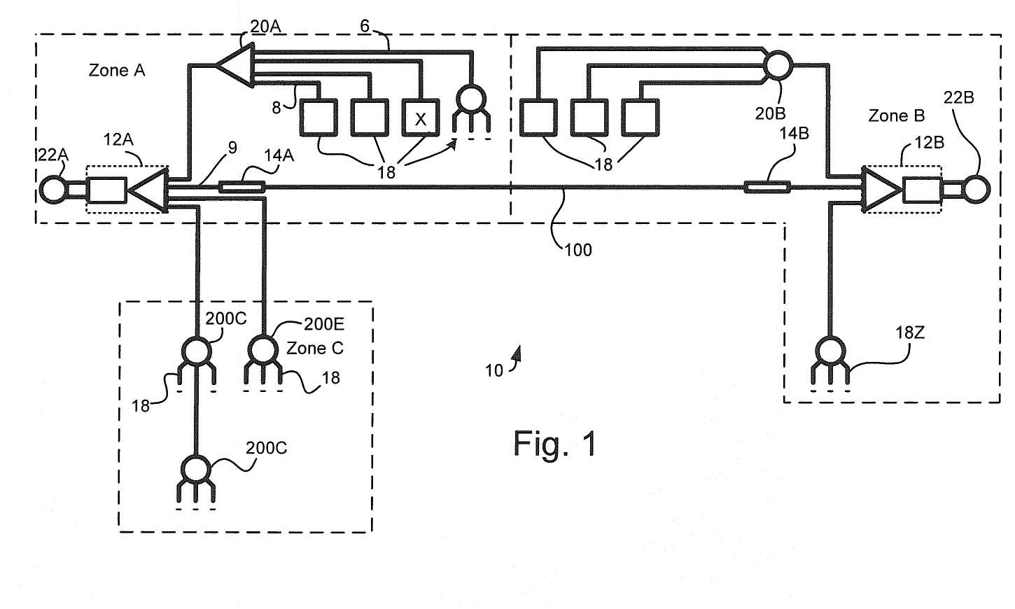

Disclosed in FIG. 1 is an exemplary system diagram of a pneumatic carrier system 10. The system is divided in to various zones each of which includes various components. For example, Zone A includes components 12A, 20A etc. Unless discussing a component of a specific zone (e.g., component 12A), the common components of each zone are generally referred to without the zone suffix (e.g., component 12 refers to component 12A, 12B etc.). In general, the pneumatic carrier system 10 transports pneumatic carriers between various user stations 18, each such transport operation being referred to herein as a “transaction”. At each of the user stations 18, a user may insert a carrier, select/enter a destination address/identification and/or a transaction priority, and then send the carrier. The system determines a path to route the carrier and begins directing the carrier through the system.

Interconnected with most stations 18 is a pass-through transfer unit 20 which orders carriers arriving through different tubes from different stations 18 into a single pneumatic tube or diverts carriers arriving through the single tube into one of the different tubes connected to the stations. The pass-through transfer unit is connected by the single tube to a turn-around transfer unit 12 and a blower 22 that provides the driving pneumatic force for carrier movement. The turn-around transfer unit 12 receives a carrier trough one of multiple pneumatic tubes, holds the carrier therein and redirects the carrier back out one of the multiple tubes once realigned. One or more transfer units 12, 200, a blower 22 and one or more stations 18 typically define a single zone (e.g., zones A, B and C). In the present embodiment, the turn-around transfer unit 12 is a point of connection to each zone. However this is not a requirement.

Within the system 10 itself, one or more devices are employable for ordering and routing carriers to their selected destinations. One type of device is a traffic control unit (TCU) 14 which is employable to receive, temporarily store and controllably release one or more carriers. Such functionality allows, for example, holding a carrier until a path through a subsequent potion of the system becomes available. Often, a carrier is temporarily parked in a TCU under power of a first blower to await the availability of a downstream path.

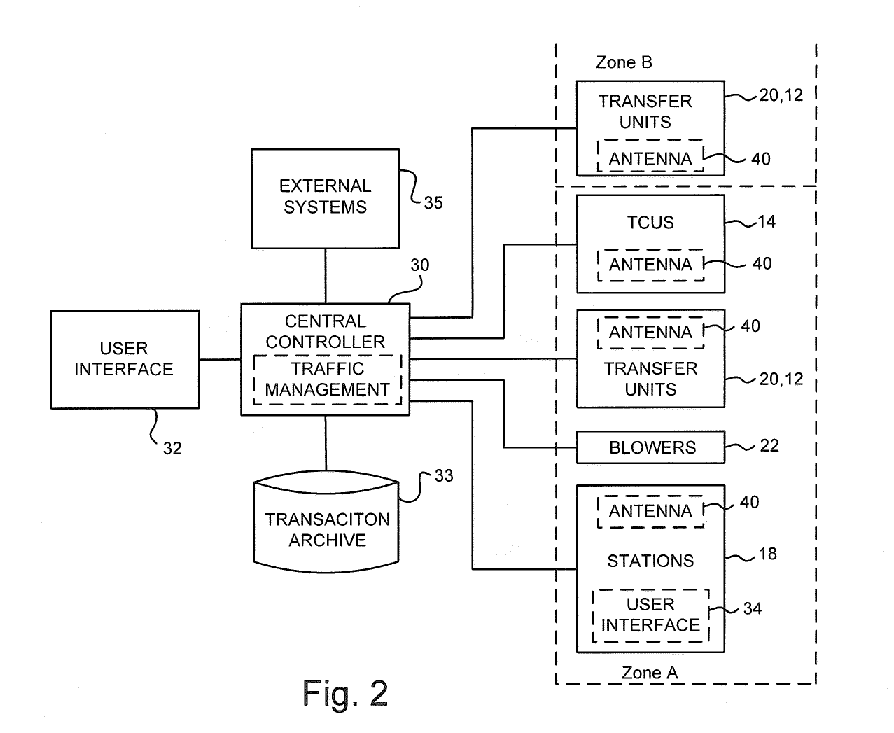

All of the components described in FIG. 1 electronically connect to a central controller which controls their operation. Disclosed in FIG. 2 is an electrical system diagram for the pneumatic carrier system 10 described herein. Providing centralized control for the entire pneumatic carrier system 10 is a system central controller (SCC) 30. The SCC 30 may include a digital processor and memory/archive 33, each of which may be connected with one or more external systems 35. SCC 30 may be configured as one or more programmable digital computers. Connectable to the SCC 30 may be one or more user interfaces 34 through which a system user may monitor the operations of the system and/or manually enter one or more commands to control its operation. Typically, at least one user interface 34 is located within a user station or near an area serviced by a station 18.

Each of the components described above in relation to FIG. 1 may include one or more electrical and/or electro-mechanical components which provide for the physical movement of a carrier within the system 10 and/or the obtainment/provision of information relating to the location of the carriers within the system 10. In this regard, the components shown in FIG. 2 are representations of the various electrical and electro-mechanical systems that may be employed by the pneumatic carrier system 10. Although in FIG. 2 they are represented single blocks, one skilled in the art will realize that the block for each type of device represents the electronics for a number of the same or similar type of components positioned throughout the system which provides for its operation. In various embodiments, each of the user stations 18, TCUs 14, transfer devices 200, 12 and/or pneumatic tubes may incorporate antenna devices/readers 40 configured to read or energize and retrieve identification information from identification devices such as bar codes, ID chips, etc. that may be incorporated into each of the carriers. Such a system is set forth in co-assigned U.S. Pat. No. 7,243,002, the contents of which are incorporated herein by reference.

Referring again to the electrical system diagram of FIG. 2, it may be seen that various transfer units 12, 20, and blowers 22 are also electrically connectable to the SCC 30. Through these connections, SCC 30 may send command signals to these devices so that they are actuated and operating at particular times and in particular sequences to affect the completion of the various carrier transactions. Other signals exchanged may include various monitoring signals that indicate the devices are operating as desired.

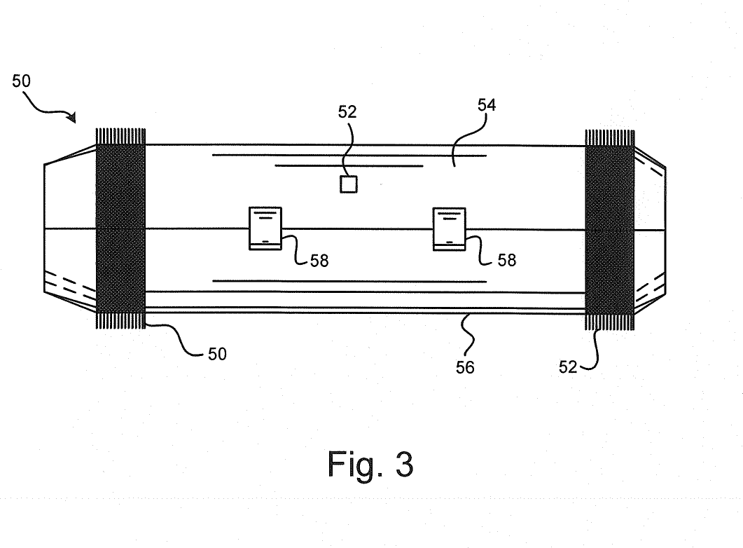

One type of carrier 50 that may be utilized with the system 10 is illustrated in FIG. 3 and includes first and second shell members 54 and 56 that collectively define an enclosed space for use in carrying materials as they are transported through the system 10. These shell members 54, 56 are adjoinably cylindrical in cross-section for use in correspondingly cylindrical pneumatic tubes of the system 10. The shell members 54 and 56 may be pivotably interconnected by a hinge member (not shown), and latches 58 may be provided for securing the first shell member to the second shell member in a closed configuration. Also included as part of the carrier 50 are wear bands 60, 62. The wear bands 60, 62 are sized to snuggly fit within the inside surface of the pneumatic tubes in order to substantially block the passage of air across a carrier 50 within such a pneumatic tube. Accordingly, this blockage results in a pressure differential across the carrier 50 that results in the carrier 50 being pushed or drawn through the pneumatic tube. In the illustrated embodiment, an ID chip 52 (e.g., RFID, bar code, etc) is attached to one of the shell members 54. In this regard, antenna device/readers may be incorporated into system components and/or pneumatic tubes within the system 10 to monitor the location and/or translocation of the carrier through the system.

### System Operation

Referring again to FIG. 1, and Zone A, an exemplary inter-zone transfer is discussed in relation to movement of a carrier from station 18X in Zone A to station 18Z in Zone B. To provide vacuum to station 18X, the system controller aligns the internal tubing of the turn-around transfer unit 12 and pass-through transfer unit 20A to provide a continuous pneumatic path between station 18X and the turn-around transfer unit 12A. Accordingly, the vacuum may be applied to these aligned tubes to draw a carrier from station 18X into the turn-around transfer unit 12A. At this time, internal tubing of turn-around transfer unit 12A may be aligned with the output tube 9. Once aligned, blower 22 provides positive pressure behind the carrier, which displaces the carrier from the turn-around transfer unit 12A and into tube 9. The carrier is received by TCU 14A where it awaits delivery into the inter-zone transfer tube 100 which interconnects to Zone B of the exemplary pneumatic tube system. Alternatively, the carrier may pass directly through the TCU 14A if all downstream components are aligned. The carrier exits the TCU 14A and is directed through the interzone transfer tube 100 under positive pressure provided by the blower 22A of Zone A and proceeds until it is received by a TCU 14C in Zone B. At this time, the blower 22A of Zone A has completed its part of the transaction and may be utilized to perform other pending transactions for Zone A. The blower 22B of Zone B provides vacuum to the carrier disposed in the TCU 14B to move the carrier into the turn-around transfer unit 12C. The turn-around transfer unit 12B is then realigned to direct the carrier to station 18Z. Accordingly, the blower 22B may provide positive pressure to move the carrier out of the turn-around transfer 12B to station 18Z. Similar processing is utilized for intra-zone transfers.

While providing an effective transfer between any two stations in either intra-zone transfer or inter-zone transfer, the inventor has recognized that the system several drawbacks. For instance, existing systems typically allow transport of a single carrier from a single station during a single air source cycle (e.g., vacuum or pressure). Further, the configuration of most transfer units provides a slow switching response that can limit system utilization.

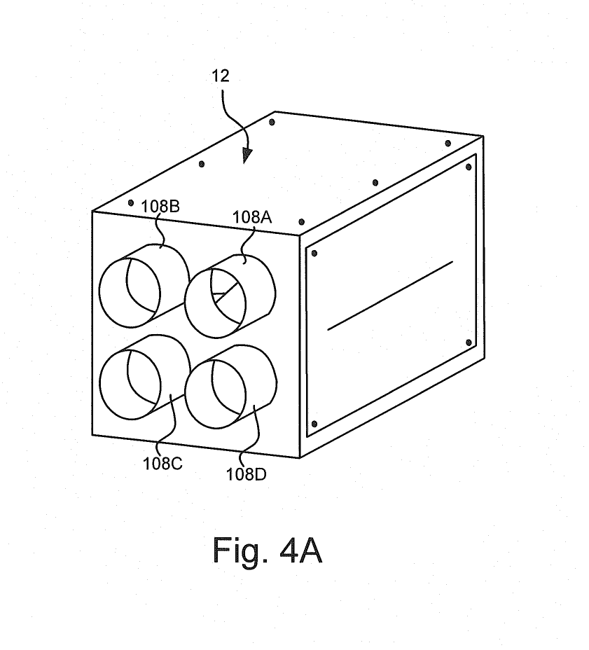

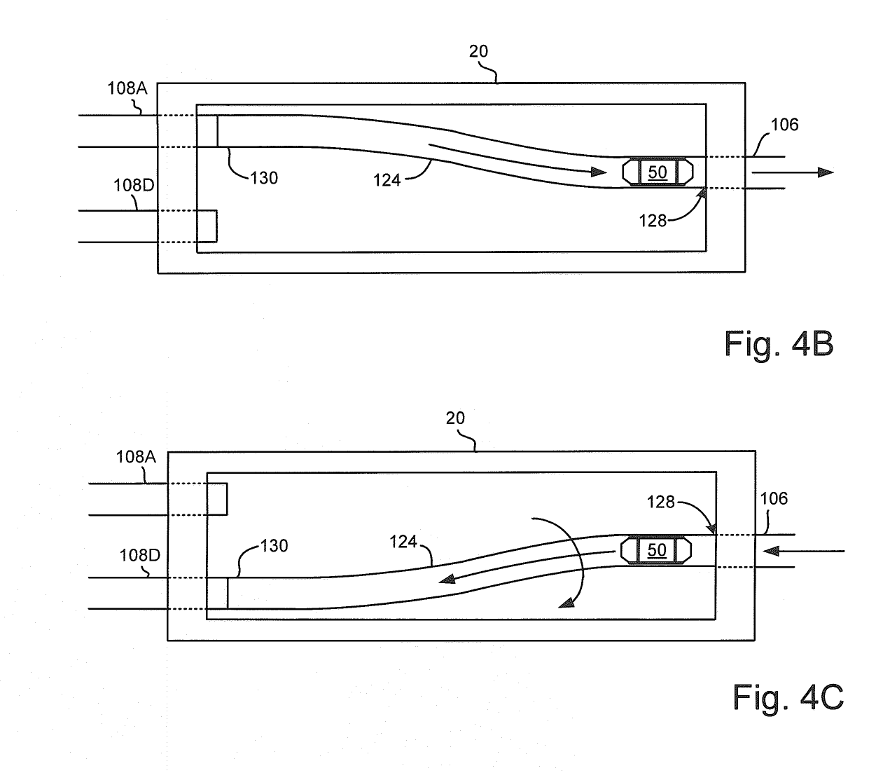

FIGS. 4A, 4B and 4C illustrate a perspective and side views of a prior art transfer unit 12. As shown, the transfer unit 20 is a diverting unit that allows for transferring a received carrier between any one of four inlet/outlet four ports 108A-108D on a first end of the transfer unit 20 and a single inlet outlet port 106 (i.e., head end port) on a second end of the transfer unit or vice versa. In any arrangement, an air source provides bi-directional airflow to the transfer unit for moving a carrier through the transfer unit. Though discussed in relation to a 4×1 device, it will be appreciated that other devices may utilize more or fewer inlet/outlet ports. To effect transfer of a received carrier between the single inlet/outlet port and any of the four inlet/outlet ports, the transfer unit 20 includes a transfer tube 124. As shown in FIG. 4B, the transfer tube 124 is a bent or offset tube that may be selectively positioned between the head end inlet/outlet port 106 any one of the four inlet/outlet ports, each of which is connected to separate tubes that may be connected to different zones, stations etc. In this regard, the transfer tube 124 is typically a curved tube having a head end 128 rotatively coupled to the head end port 106 and a transfer end 130 that is operative to rotate into an adjacent position with any one of the inlet/outlet ports 108A-108D. In this regard, the central axis of each of the inlet/outlet ports 108A-108D are aligned (e.g., parallel) with the axis of rotation of the transfer tune 124. Generally, a motor (not shown) is interconnected proximate to the head end of the transfer tube 124 that is operative to rotate the tube utilizing, for instance, sprockets, gears, etc.

In operation, the transfer end 130 of the transfer tube 124 is positioned adjacent to one of the inlet/outlet ports 108A and air flow is initiated through the transfer unit 20 (e.g., a blower may provide airflow in a first direction) such that a carrier 50 may drawn into the transfer unit 12 via the connected port 108A. The carrier 50 moves into the transfer tube 124 and exits the head end port 106. The offset transfer end 130 of the transfer tube 124 may then be rotated to an adjacent position with any one of the four inlet/outlet ports (e.g., port 108D) to handle another carrier. See FIG. 4C. The inertia of the offset transfer tube limits the speed at which the transfer unit can be reoriented.

### High Speed Switch

Aspects of the presented inventions are based upon the realization that the air source or blower of a pneumatic tube system has adequate power to move multiple carriers in a single transport cycle (e.g., vacuum or pressure). Further, the ability to quickly switch a pneumatic airflow between differing pneumatic tubes may allow the application of a single air source cycle airflow to different pneumatic paths and thereby allow for handling multiple carriers during a single cycle improving system performance. In one specific aspect, rapid switching of an airflow may allow for moving multiple carriers to or from multiple carrier docks in a single user station.

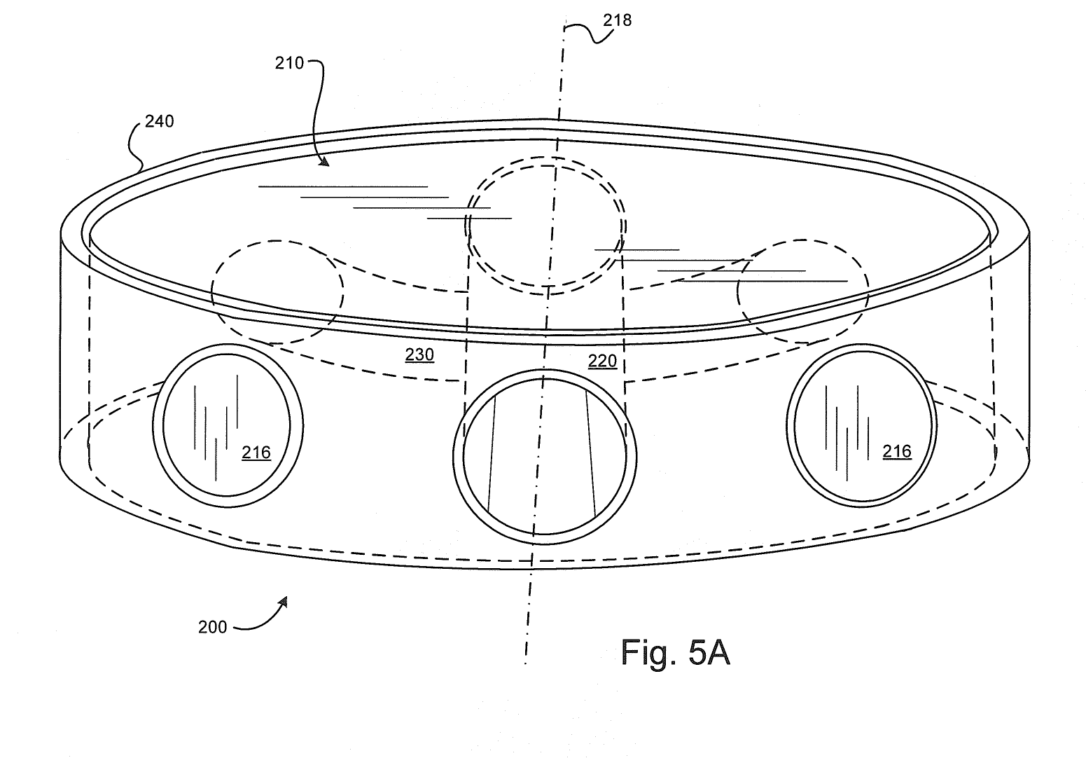

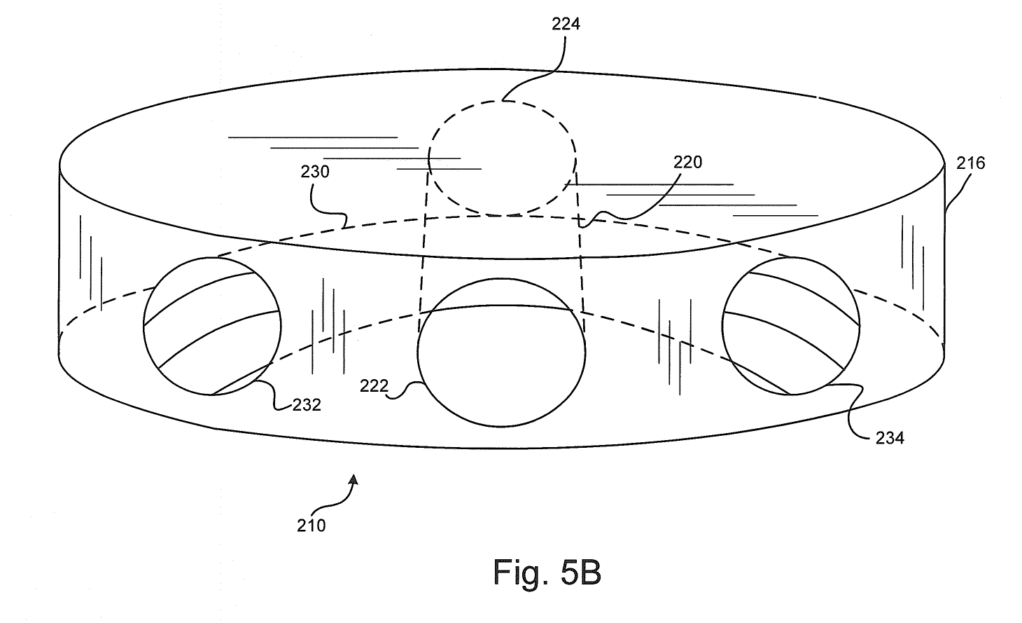

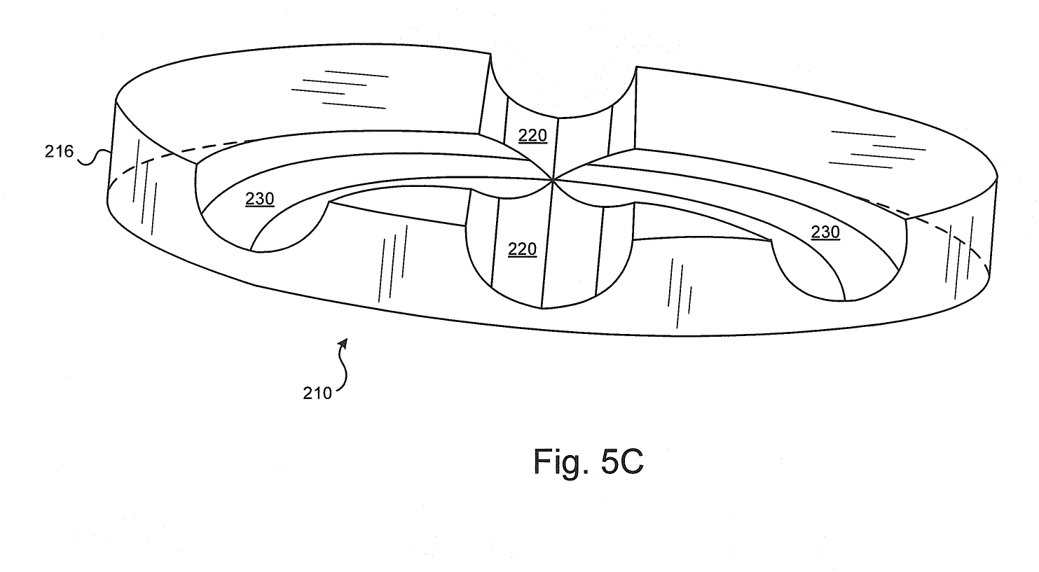

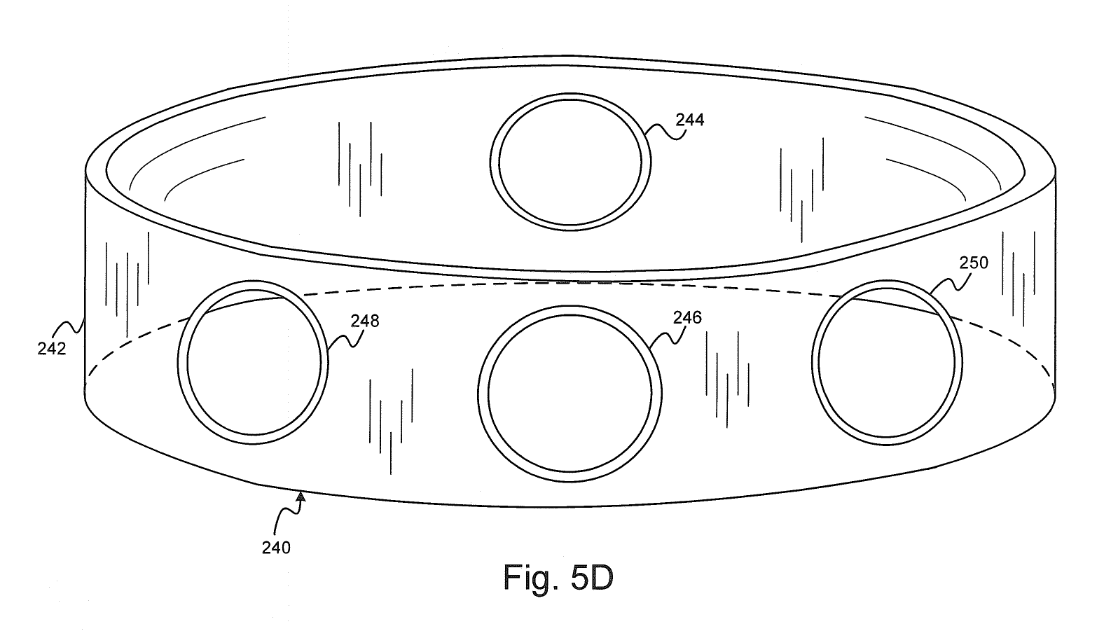

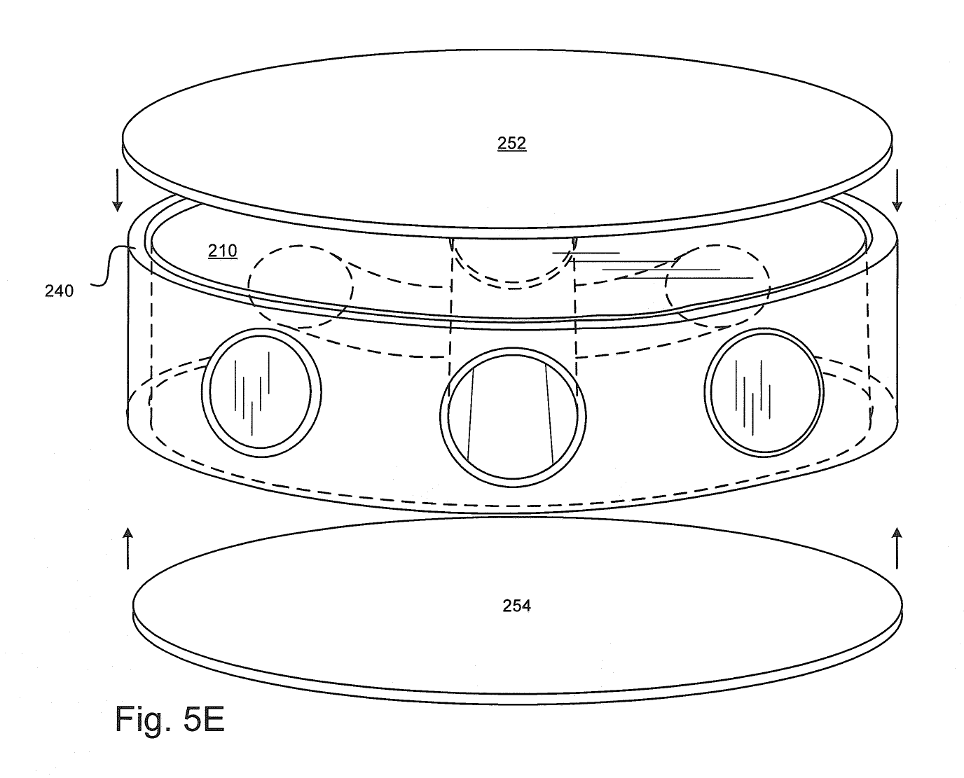

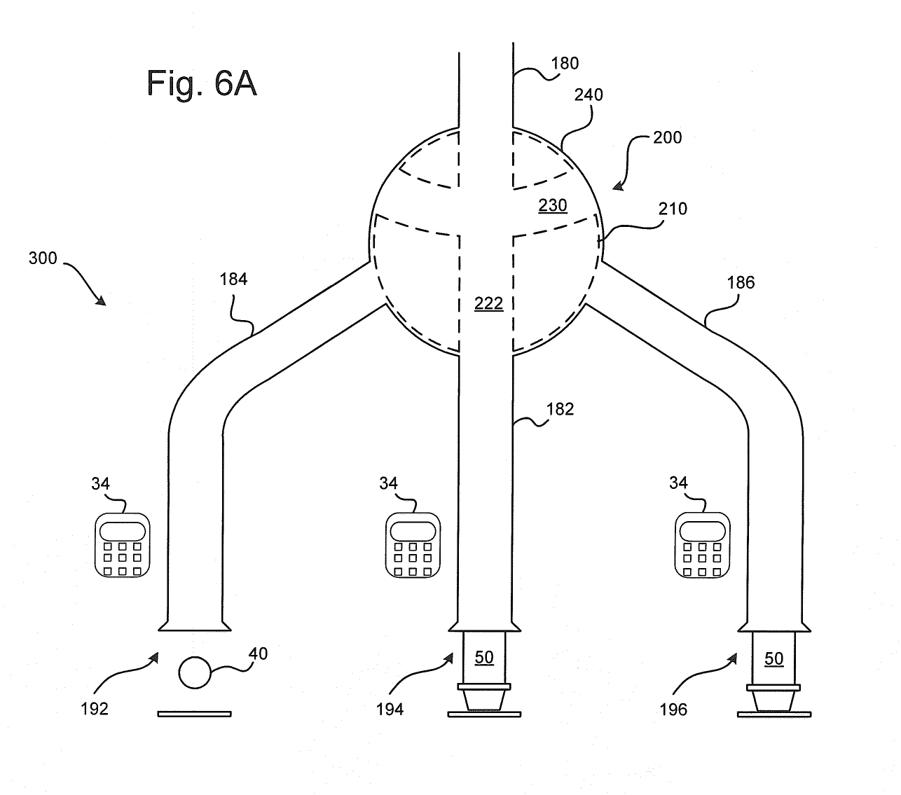

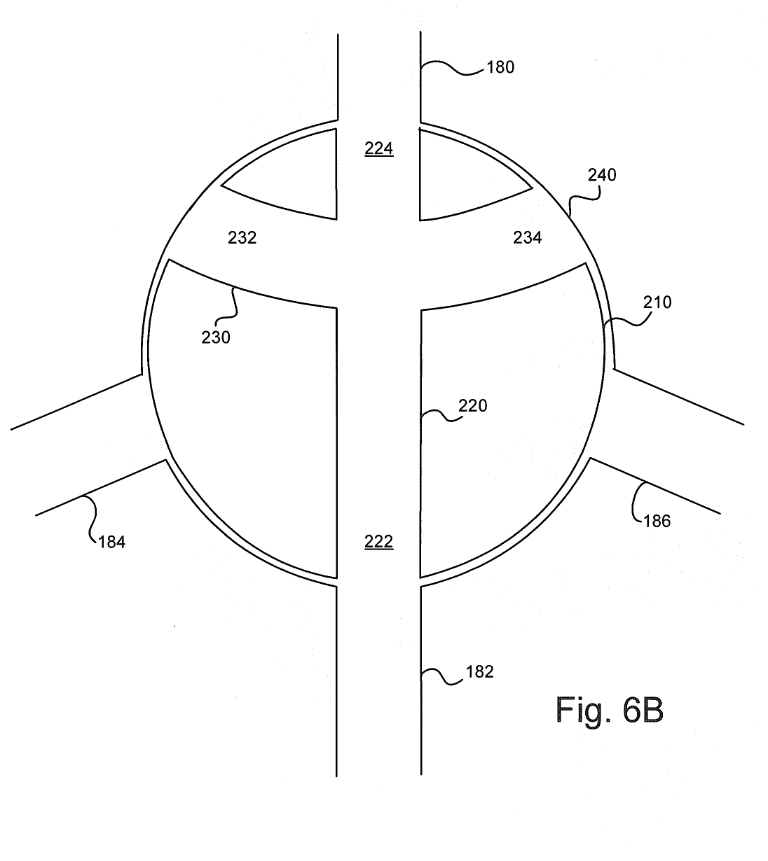

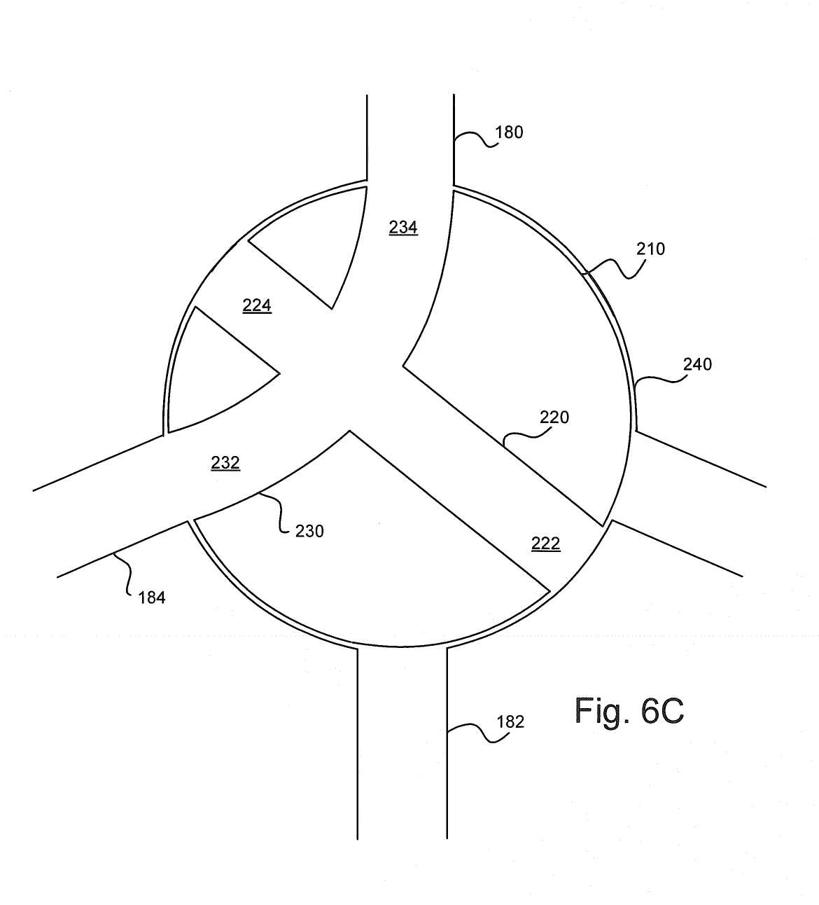

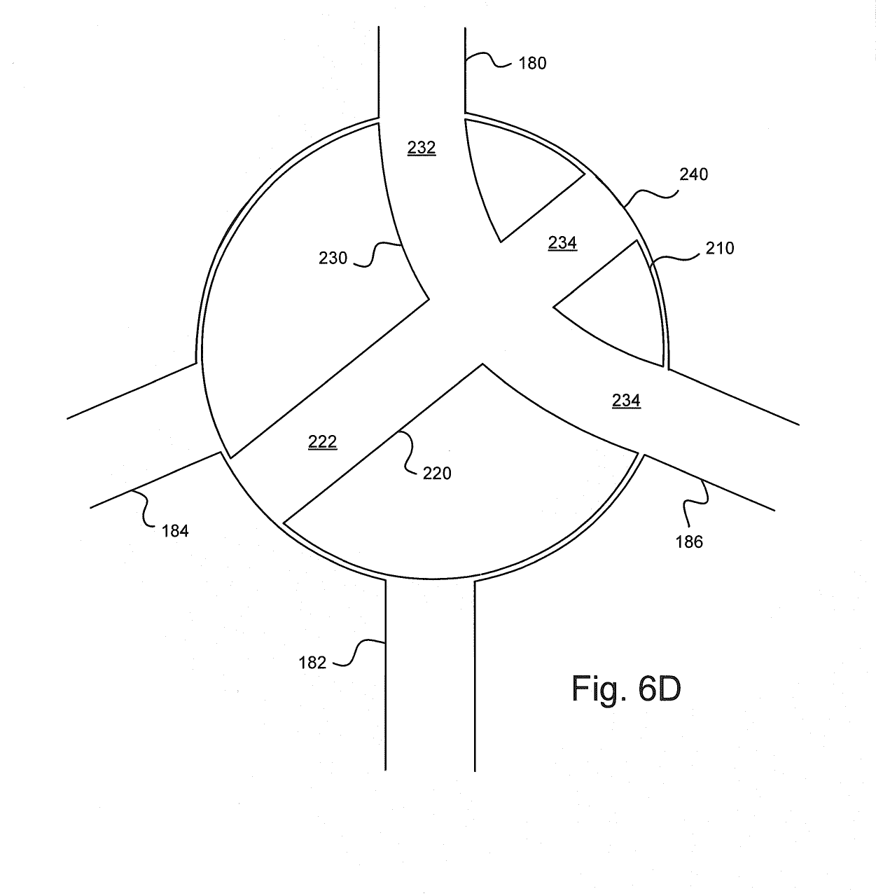

FIGS. 5A-6D variously illustrate a high speed transfer switch that allows for reducing switching times. Such a high speed transfer switch may replace some or all of the prior art transfer units in a pneumatic tube system. FIGS. 5A-5E illustrate one embodiment the high speed transfer switch 200. As shown, the high speed switch 200 includes a rotary disc 210 that is disposed within an annular wall 240. Specifically, the disc 210 is sized to be received within an interior of the annular wall 240 such that the disc may rotate therein. In this regard, the disc is operative to rotate about an axis 218 that extends through the center of the cylindrical disc 210 between its top and bottom surfaces. See, for example, FIG. 5A.

As illustrated, the disc 210 includes a first passageway 220 and a second passageway 230 that each extend between a pair openings in a sidewall 216 of the rotating disc 210. See FIG. 5B. Specifically, the first passageway 220 extends between a first opening 222 and a second opening 224. As shown, the first passageway 220 extends straight through the center of the rotating disc 210. That is, the first opening 222 and second opening 224 are disposed on opposing surfaces of the rotating disc 210 and define a straight passageway that intersects a center of the rotating disc 210. The second passageway 230 extends between a third opening 232 and a fourth opening 234. In contrast to the first passageway 220, the second passageway 230 is a curved passageway that arcs between the third opening 232 and the fourth opening 234. In this regard, the second passageway 230 is an arcuate passageway that passes through the disc 210.

Centerline axes of the first and second passageways 220, 230 are transverse to the axis of rotation of the disc 210. Further, as the rotating disc 210 rotates about a central axis 218, high speed rotation of the disc 210 is possible. That is, as opposed to prior transfer units that utilize an offset tube, the rotational inertia of the rotating disc is relatively small. This enables for the rapid reorientation of the different passageways 220, 230 to selectively interconnect different pneumatic tubes, as discussed below.

FIG. 5C shows a cross-sectional view of a bottom half of the disc 210 to better illustrate the passageways 220 and 230. As shown, each passageway 220, 230 is substantially circular in cross-section to receive a generally circular pneumatic carrier. That is, the passageways 220, 230 are sized to conformably receive the wearbands of a pneumatic carrier 50. See FIG. 3.

FIG. 5D illustrates the annular wall 240 into which the rotating disc 210 is disposed. As shown, the annular wall 240 is illustrated as a continuous annular element having an open interior that is sized to receive the rotating disc. Other embodiments may utilize an annular wall made of multiple sections. Disposed through a sidewall 242 of the annular wall 240 are four ports. Specifically, the annular wall 240 includes a first port 244 and a second port 246 that are positioned through the sidewall 242 to allow selective pneumatic connection via the first passageway 220 of the rotating disc in one disc orientation, as is further discussed below. The annular wall 240 also includes a third port 248 and a fourth port 250. The third port 248 allows for selective pneumatic connection to the first port 244 via the second passageway 230 in another angular orientation of the rotating disc 210. Likewise, and the fourth port 250 allows selective pneumatic connection to the first port 244 in further angular orientation of the rotating disc 210.

FIG. 5E illustrates top and bottom plate 252 and 254, respectively, that may be attached to the upper and lower edges, respectively, of the annular wall 240. Once assembled, the rotating disc is encapsulated within the interior of the annular wall 210 and the plates 252, 254. An actuator (not shown) may extend through one or both of the plates in order to engage the annular disc 210. For instance, an electric motor may have a shaft interconnected to the central axis 218 of the rotating disc (not shown) to rotate the disc 210 within the annular wall 240. In a further arrangement, the disc may include a gear around the periphery of the sidewall that may be engaged by an actuator disposed on the edge of the rotating disc. Further, it will be appreciated that various bushings, bearings, and other elements may be disposed between the interconnecting portions of the rotating disc and annular sidewall to allow for rotational movement of the disc within the interior of the annular wall.

FIG. 6A illustrates the rotating switch 200 as utilized to selectively interconnect a first pneumatic tube 180 with any of a second pneumatic tube 182, a third pneumatic tube 184, and fourth pneumatic tube 186. Referring to FIG. 5D and FIG. 6A, it is noted that the ports 244-250 of the annular wall 240 are each interconnected to one of the pneumatic tubes 180-186. Specifically, the first port 244 is interconnected to the first pneumatic tube 180, the second port 246 is interconnected to the second pneumatic tube 182, the third port 248 is interconnected to the third pneumatic tube 184, and the fourth port 250 is connected to the fourth pneumatic tube 186. Once so connected, any of the three pneumatic tubes 182, 184, 186 may be selectively pneumatically interconnected to the first pneumatic tube 180 by the orienting the rotating disc 210 to align one of the passageways 220 or 230 between the first pneumatic tube 180 and a selected one of the second, third, and fourth pneumatic tubes 182, 184, 186.

As shown in FIGS. 6A and 6B, the rotating disc 210 is oriented to align the first passageway 220 with the first pneumatic tube 180 and the second pneumatic tube 182. In this regard, the first opening 222 through the sidewall of the disc 210 is aligned with the first port 244 of the annular wall and the second opening 224 of the first passageway 220 is aligned with the second port 244 of the annular wall 240. Accordingly, the passageway 220 pneumatically interconnects the first pneumatic tube 180 and the second pneumatic tube 182. Importantly, the annular wall 240 also blocks the openings 232, 234 of the second passageway 230 to prevent airflow through these opening. Likewise, the sidewall 216 of the rotating disc 210 blocks the third port 248 and fourth port 250 of the annular wall 210. See for instance FIGS. 5A and 5D. In this regard, when the first passageway 220 interconnects the first pneumatic tube 180 and the second pneumatic tube 182, the other openings within the disc 210 are sealed by the annular wall 240 and the other ports in the annular wall 240 are blocked by the sidewall 216 of the rotating disc 210. In this regard, the switch 200 provides a seal that maintains airflow between the connected pneumatic tubes via the passageway. Seals (e.g., fabrics etc.) may line the inside of the annular wall 240 and/or the sidewall of the disc 210 to improve sealing.

FIG. 6C illustrates the rotating disc 210 as disposed in a second angular orientation relative to the annular sidewall 240 and the pneumatic tubes 180-186. In this orientation, the rotating disc 210 connects the first pneumatic tube 180 with the third pneumatic tube 184. In this orientation, the second passageway 230 is utilized to interconnect these pneumatic tubes. Specifically, the first opening 232 in the sidewall of the rotating disc is aligned with the third pneumatic tube 184 and the second opening 234 in the sidewall of the rotating disc 210 is aligned with the first pneumatic tube 180. As with the first orientation, the openings 222, 224 in the other passageway 220 are blocked by the annular sidewall 240 and the other ports in the annular sidewall 240 are blocked by the sidewall 216 of the rotating disc 210.

FIG. 6D illustrates a third angular orientation of the rotating disc 210. In this orientation, the second passageway 230 is again utilized to interconnect to two of the pneumatic tubes. Specifically, the second passageway 230 is utilized to interconnect the first pneumatic tube 180 to the fourth pneumatic tube 186. However, in this orientation the first opening 232 of the second passageway 230 in the sidewall of the rotating disc 210 is aligned with the first pneumatic tube 180 and the second opening 234 is aligned with the fourth pneumatic tube 186. In this regard, the second curved passageway 230 is utilized to selectively connect the first pneumatic tube 180 to either of the third pneumatic tube 184 or the fourth pneumatic tube 186 based on the orientation of the disc 210.

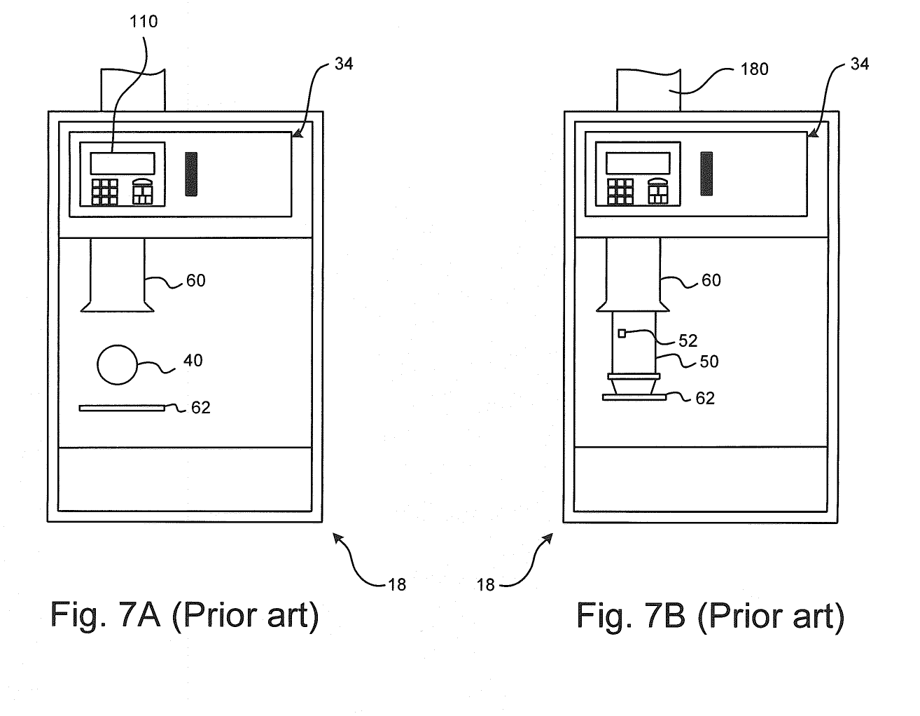

The high speed switch 200 may be utilized as a transfer unit in a pneumatic tube system 10 as illustrated in Zone B of FIG. 1. In addition, the high speed switch may be utilized to provide a multi-carrier station. FIGS. 7A and 7B illustrate front views of a prior art carrier handling station 18. As shown, the station 18 includes a dispatcher 60 connected to a pneumatic tube 180 that is employable for transporting and delivering carriers 50 to and from the station 18. Such stations typically also include a user interface 32 having a control panel, which a system user may employ for receiving notifications and/or entering data, for example, destination information, priority information, and security information. Also positioned relative to the dispatcher 60 is a carrier holder 62 and in some instances an antenna device/reader 40. The holder 62 is configured such that a system user may place a carrier on the holder 62 and enter destination information through the control panel. Once all the appropriate information has been entered, the dispatcher 60 allows the carrier 50 to move into the pneumatic tube 180 for transport to a selected destination upon an airflow (e.g., vacuum) being established in the pneumatic tube 180. Such stations may be configured to drop incoming carriers into a bin such that the station may receive multiple carriers. However, such stations only permit the staging of a single carrier for dispatch.

Previous attempts to provide carrier stations that allow for staging multiple carries for dispatch have entailed the use of a rotating carriage that has multiple parallel receiving tubes that are parallel with the axis of rotation of the carriage. In such stations, the parallel receiving tubes may be selectively rotated into alignment with a pneumatic tube. One such carrier station is illustrated in U.S. Pat. No. 6,702,150. However, such rotating carriage stations have not found widespread acceptance as the carrier stations are considerably deeper than single staging stations, which may have a depth of as little as about eight inches. That is, a depth rotating carrier stations is typically between eighteen inches and two feet. Accordingly, such stations protrude into the area where they are mounted and in such areas space is often of a concern. Further, where such stations permit a carrier to pass through, such stations often fail to adequately seal.

One exemplary embodiment of a multi-carrier handling station is illustrated in FIG. 6A. As shown, the pneumatic tubes 182, 184 186 that are selectively connectable to the first pneumatic tube 180 each terminate at a carrier dock 192, 194 196, respectively. In such an arrangement, each carrier dock may include a user interface 34 for entering destination information for staged carriers 50. As will be appreciated, this permits multiple carriers to be staged at a single station for delivery to other locations within the pneumatic tube system. Accordingly, once one or more carriers 50 are staged for delivery, the system control 30 may identify the presence of these carriers by inputs received from the user interfaces 34 or by sensing the presence of the carriers utilizing a reader/antenna device 40, which may be associated with each carrier dock.

Once carriers are identified and system components are available to move those carriers, the rotating switch may be oriented to apply an air flow to a first carrier dock (e.g., dock 194) to move the staged carrier into the pneumatic tube system. See FIG. 6A. Once the first carrier moves through the switch 200, which may be determined based on timing or by utilizing an antenna/reader associated with the switch and/or first pneumatic tube 180 (not shown) the rotating disk 210 may be reoriented to apply the airflow to a second carrier dock (e.g., dock 196; see FIG. 6D). Accordingly, the second carrier may be moved out of the second carrier dock and into the pneumatic tube system. Likewise, such a multi-carrier handling station allows for delivery of multiple carriers to different docks of the station. The use of the high-speed switch 200 allows for rapidly altering the pneumatic path between the various carrier docks and the first pneumatic tube 180. In some arrangements, switching times may be less than five seconds, less than two seconds or even less than one second. Further, the illustrated multi-carrier handling station provides a multi-port carrier station having a low profile. That is, the depth of the multi-carrier handling station may be no more than a prior art single carrier handling station.

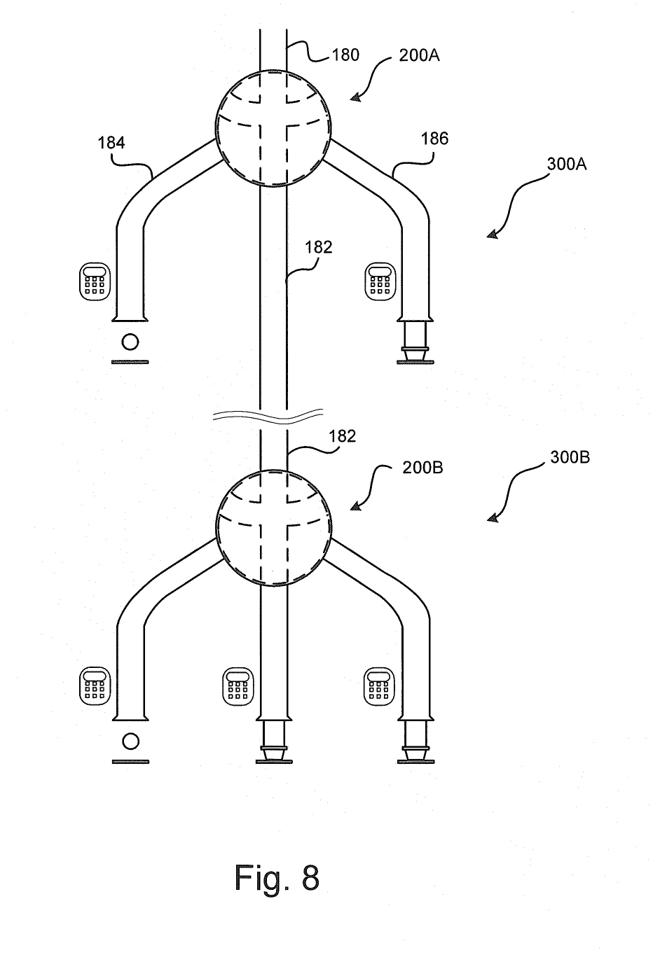

The high-speed switch 200 may also be utilized to provide a pass-through carrier station as illustrated in FIG. 8 and in Zone C of FIG. 1. In this arrangement, one of the tubes 182 exiting a high speed switch 200A of a first carrier station 300A does not terminate at a carrier dock. Rather, one of the tubes (e.g., tube 182) continues to a second carrier station 300B, which in the illustrated embodiment utilizes a second high speed switch 200B connected to three additional carrier docks. However, it will be appreciated that the tube 182 may connect to a single dock carrier station, another pneumatic tube zone, etc. In the illustrated embodiment, a carrier may pass through the first station 300A unimpeded to a second carrier station 300B, which may be located at a second location within a facility (e.g., different floor etc.) In any arrangement, the high speed rotating switch provides the ability to pass through a carrier station while avoiding the sealing problems associated with prior art pass-through carrier stations.

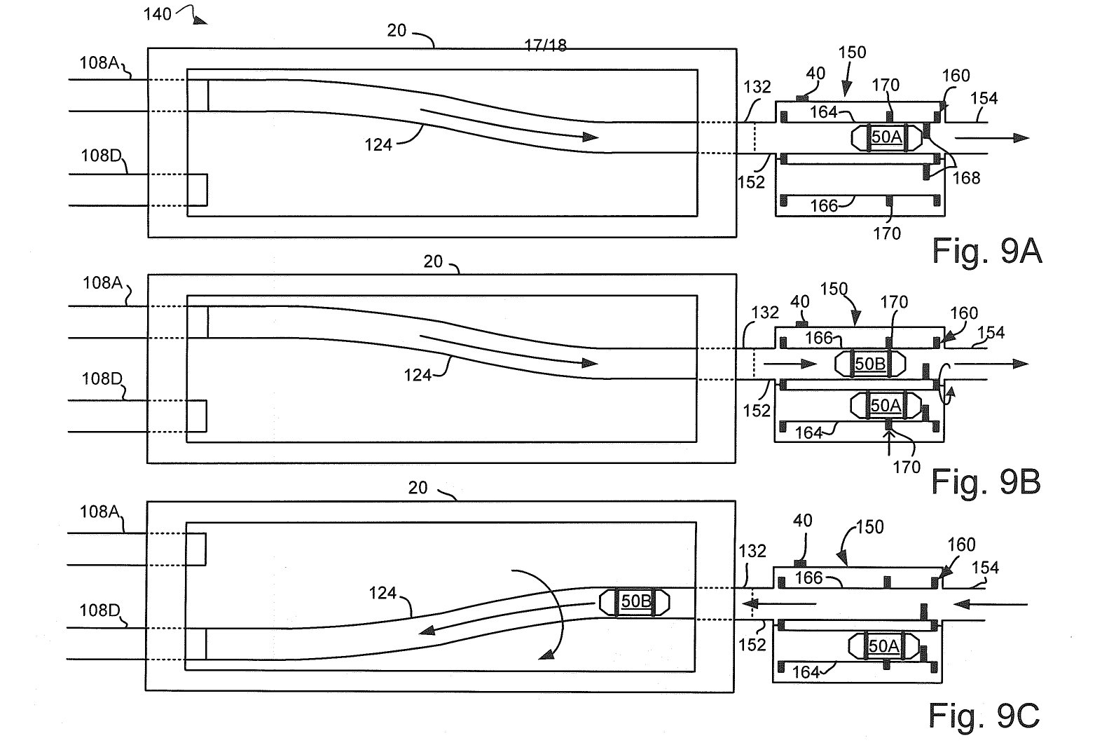

In order to handle multiple carriers moving through the first pneumatic tube 180 at the same time, it may be necessary to incorporate an in-line tube brake that allows for spacing those carriers. One such in-line pneumatic tube brake is set forth in co-owned U.S. Pat. No. 8,382,401, the entire contents of which is incorporated by reference herein. Further, in order to handle multiple carriers in a single transaction, it may be necessary to utilize a turnaround transfer unit 12 that can receive and hold multiple carriers. FIGS. 9A-9C illustrate a turnaround transfer unit 140 that is operative to handle multiple carriers. Generally, the turnaround transfer unit 140 is formed of a diverter 20 and a sequencer or carrier handling device 150. The diverter 20 is substantially similar to the transfer unit described in FIGS. 4A-4C above. Alternatively, a high speed switch 200 may be utilized. In any arrangement, it will be appreciated that the transfer unit may interconnect multiple input output ports 108A-N to a single head end port 132, for example, via an offset transfer tube 124. Connected to the head end port 132 is a carrier port 152 of the carrier handling device 150. Accordingly, carriers passing through the diverter 20 pass directly into the carrier handling device 150 via the carrier port 152. The carrier port 152 is disposed within a housing 156 which is fluidly interconnected on an opposing end to an air source via an air source port 154. The air source is operative to provide bidirectional air flow through the carrier handling device 150, the diverter 20 and into and from the pneumatic tube system.

Disposed within the housing 156 is a carriage 160 that supports at least first and second carrier docks 164, 166. The carrier docks 164, 166 are formed of lengths of tubing that are supported between first and second ends 162A, 162B of the carriage 160. The carriage 160 is interconnected within the housing 156 via first and second pivots. Accordingly, a motor or actuator (not shown) is operative to rotate the carriage 160 about the pivots. In this regard, the carriage 160 is operative to align each of the carrier docks 164, 166 with the carrier port 152. Accordingly, this allows for aligning one of the carriage docks (e.g., 164) with the carrier port 152 in order to receive a first carrier 50A. This is illustrated in FIG. 9A. During such an operation, the air source (not shown) may provide airflow into the transfer unit 142 and into the carrier handling device 150 such that the carrier may pass into the carrier dock 164. That is, the carrier 50A may proceed into the carrier dock 164 until it engages a stop 168 located on the distil end of the carrier dock 164. This stop 168 extends into the bore of the carrier dock 164 to impede passage of the carrier 50A there through.

Once the first carrier 50A is received within the carrier dock 164, a gripper 170 that extends through a sidewall of the carrier port 164 may be moved into contact with an outside surface of the carrier 50A to maintain the carrier locked within the carrier dock 164. However, this is not a requirement. Once the first carrier 50A is located within the first carrier port 164, the carriage 160 may rotate about the pivots to align the other carrier dock 166 with the carrier port 152. This is illustrated in FIG. 9B. Likewise, a second carrier 50B may be received in the second carrier dock 166 by the carrier handling device 150 once so aligned.

Once the carrier handling device 150 has received two or possibly more carriers, those carriers may be displaced from the carrier handling device 150 via the application of airflow in an opposing direction as illustrated in FIG. 9C. Further, the order in which the carriers 50a, 50b are received may be altered. That is, depending on where the carriers are slated for delivery, the carriage 160 may rotate to deliver one of the carriers prior to delivery of another of the carriers. A multi-carrier handling turnaround transfer unit in accordance with FIGS. 9A-9C is set forth in co-owned and co-pending U.S. patent application Ser. No. 14/202,545 the entire contents of which is incorporated herein by reference.

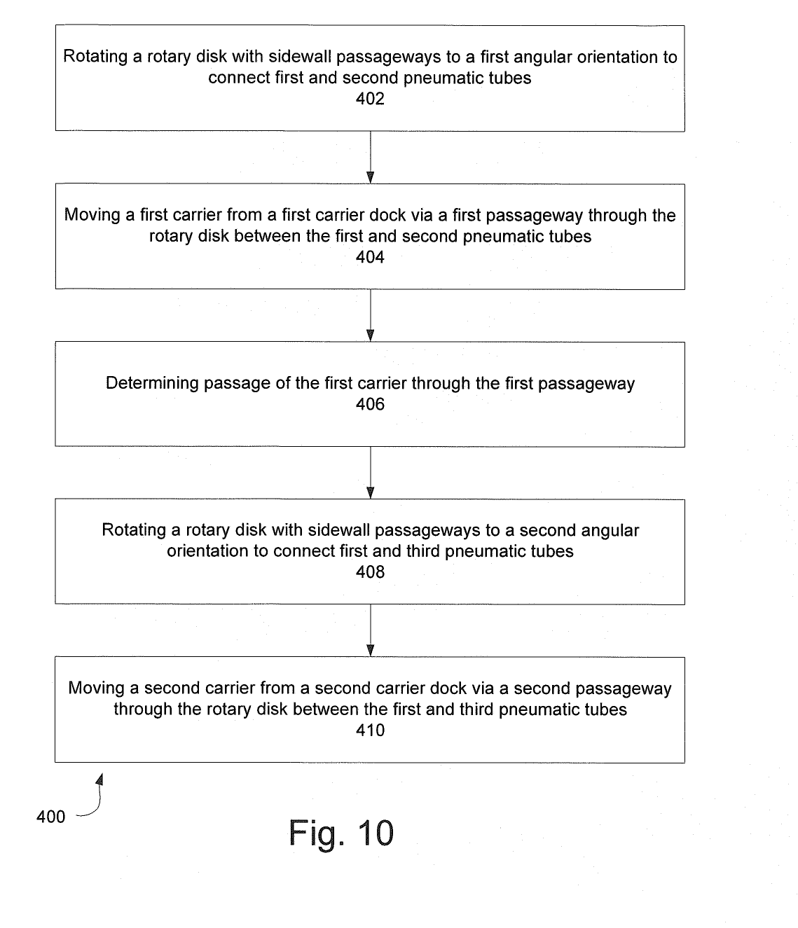

FIG. 10 illustrates one process that may be implemented utilizing various aspects of the system described above. Specifically, FIG. 10 illustrates an overall process 400 for moving at least first and second carriers from first and second carrier docks to a carrier handling device during a single air source/blower cycle. Initially, the process 400 includes rotating 402 a rotary switch with first and second passageway extending through its sidewall to a first angular orientation to establish a first pneumatic path between a first set of pneumatically tubes. Once oriented, a first carrier from moves 404 from a first carrier dock and into the pneumatic tube system. Once the first carrier passes 406 through the rotary switch, the switch is rotated 408 to a second angular orientation to establish a second pneumatic path between a second set of pneumatically connected tubes. The process then moves 410 a second carrier from a second carrier dock and into the pneumatic tube system.

The foregoing description of the presented inventions has been presented for purposes of illustration and description. Furthermore, the description is not intended to limit the inventions to the forms disclosed herein. Consequently, variations and modifications commensurate with the above teachings, and skill and knowledge of the relevant art, are within the scope of the presented inventions. The embodiments described hereinabove are further intended to explain best modes known of practicing the inventions and to enable others skilled in the art to utilize the inventions in such or other embodiments and with various modifications required by the particular application(s) or use(s) of the presented inventions. It is intended that the appended claims be construed to include alternative embodiments to the extent permitted by the prior art.

What is claimed:

1. A pneumatic switching device for directing a pneumatic carrier between at least a first pneumatic tube and a selected one of at least a second pneumatic tube and a third pneumatic tube, comprising:
a disk controllably rotatable about a central axis of said disk;
a first passageway extending through a sidewall of said disk between first and second openings in said sidewall of said disk;
a second passageway extending through said disk between third and fourth openings in said sidewall of said disk, wherein said first and second passageways are sized to permit passage of a pneumatic carrier there through;
an actuator for controllably rotating said disk, wherein in a first angular orientation said first passageway is oriented to connect the first pneumatic tube with the second pneumatic tube and in a second angular orientation said second passageway is oriented to connect the first port with the third pneumatic tube.

2. The device of claim 1, wherein said first passageway and said second passageway are at least partially transverse.

3. The device of claim 2, wherein central axes of said first and second passages lie in a common plane, wherein said common plane is transverse to said central axis of said disk.

4. The device of claim 1, wherein said first passageway is linear between said first and second openings in said sidewall of said disk.

5. The device of claim 4, wherein said second passageway is curved between the third and fourth openings in said sidewall of said disk.

6. The device of claim 1, further comprising:
an annular wall extending around said sidewall of said disk, wherein said annular wall has a first port aligned with the first pneumatic tube, a second port aligned with the second pneumatic tube, and a third port aligned with the third pneumatic tube.

7. The device of claim 6, wherein in said first angular orientation, said first opening in said sidewall is aligned with said first port in said annular wall and said second opening in said sidewall is aligned with said second port in said annular wall and wherein said third and fourth openings in said sidewall are covered by said annular wall.

8. The device of claim 6, wherein in said second angular orientation, said third opening in said sidewall is aligned with said first port in said annular wall and said fourth opening in said sidewall is aligned with said third port in said annular wall and wherein said first and second openings in said sidewall are covered by said annular wall.

9. The device of claim 8, wherein in a third angular orientation, said fourth opening in said sidewall is aligned with the first port in said annular wall and said fourth opening is aligned with a fourth port in said annular wall, wherein said fourth port is aligned with a fourth pneumatic tube.

10. A pneumatic tube station for use in a pneumatic tube system, comprising:
an first pneumatic tube for dispatching and receiving carriers to and from a pneumatic tube system, respectively;
a rotating switch having first and second passageways extending there through, wherein each passageway is transverse to an axis of rotation of said switch and at least one end of each of said first and second passageways is selectively alignable with said inlet pneumatic tube;
a second pneumatic tube connected to said rotating switch, wherein said first passageway pneumatically connects said first pneumatic tube to said second pneumatic tube when said rotating switch is in a first angular orientation;
a third pneumatic tube connected to said rotating switch, wherein said second passageway pneumatically said first pneumatic tube to said third pneumatic tube when said rotating switch is in a second angular orientation; and
at least one carrier dock connected to at least one of said first and second pneumatic tubes.

11. The device of claim 10, wherein said at least one carrier dock is connected to said second pneumatic tube and wherein said third pneumatic tube is connectable to a downstream system component.

12. The device of claim 10, wherein said downstream system component comprises a downstream pneumatic tube station, wherein carriers passing through said first passageway into said third pneumatic tube pass through said pneumatic station free of stopping.

13. The device of claim 10, wherein said first passageway is a linear passageway and said second passageway is a curved passageway, wherein said first and second passageways are at least partially transverse.

14. The device of claim 13, wherein said first and second passageways intersect within an interior of said rotating switch.

15. The device of claim 13, wherein said first passageway extends through a sidewall of said rotating switch between first and second openings in said sidewall of said rotating switch and said second passageway extends through said sidewall of said rotating switch between third and fourth openings in said sidewall of said rotating switch.

16. The device of claim 15, further comprising:
an wall extending around said sidewall of said rotating switch, wherein said wall has a first port aligned with the first pneumatic tube, a second port aligned with the second pneumatic tube, and a third port aligned with the third pneumatic tube,

17. The device of claim 16, wherein in said first angular orientation, said first opening in said sidewall is aligned with said first pneumatic tube and said second opening in said sidewall is aligned with said second pneumatic tube and wherein said third and fourth openings in said sidewall are covered by said wall and wherein in said second angular orientation, said third opening in said sidewall is aligned with said first pneumatic tube and said fourth opening in said sidewall is aligned with said third pneumatic tube and wherein said first and second openings in said sidewall are covered by said wall.

18. The device of claim 17, wherein in a third angular orientation, said fourth opening in said sidewall is aligned with said first pneumatic tube and said third opening is aligned with a fourth pneumatic tube and a fourth port in said wall, and wherein said first and second openings in said sidewall are covered by said wall.

19. The device of claim 10, wherein said at least one carrier dock further comprises:
first and second carrier docks connected to said first and second pneumatic tubes.

20. The device of claim 10, further comprising:
a reader associated with each said carrier dock, wherein said reader is operative to identify a presence of a carrier disposed in said carrier dock and generate an output indicative of the presence of said carrier.
